(19) United States
(12) Patent Application Publication
(10) Pub. No.: US 2003/0088517 A1
(43) Pub. Date: May 8, 2003

(54) System and method for controlling access and use of private information

(75) Inventor: Marshall Medoff, Brookline, MA (US)

Correspondence Address: James M. Smith, Esq., HAMILTON, BROOK,, SMITH & REYNOLDS, P.C., Two Militia Drive, Lexington, MA, 02421-4799, US

(73) Assignee: Xyleco, Inc., Brookline, MA

(21) Appl. No.: 09/961,799

(22) Filed: Sep. 24, 2001

Related U.S. Application Data
(60) Provisional application No. 60/283,571, filed on Apr. 13, 2001.

(51) Int. Cl. G06F 17/60

(52) U.S. Cl. 705/59

(57) ABSTRACT

A private information control system provides access to private information, such as private offerings to potential investors in compliance with securities law. The system includes legal and technical control features to restrict access and use of private information over a network, such as the Internet. In particular, a server provides registration and user license agreement forms to assure that a client/user is qualified under the securities law. From the registration form, the server confirms the client/user status depending on the type of private information. When an authorized client/user requests private information, the server returns a cookie to the client device to provide access to the private financial information from only that client device. The server also transmits instructions to restrict unauthorized use of private information, such as printing and copying. The registration, user license agreement, and private information are encrypted to for secure transmission between the server and client.

### RELATED APPLICATIONS

This application claims the benefit of U.S. Provisional Application No. 60/283,571 filed Apr. 13, 2001, entitled “Network Based Private Offerings” by Marshall Medoff, the entire teachings of all are incorporated herein by reference.

### BACKGROUND OF THE INVENTION

In investment banking and financial services, a company or corporation raises capital by issuing Debt (Loan) or Equity (Stock) securities. The securities may be offered through an Initial Public Offering (IPO) or Private Placement Memorandum (PPM). The issuing of securities is a complex matter involving compliance with various securities rules and private institutional standards. Furthermore, during and after issuance of securities, the issuer typically needs effective marketing to promote their products or services. In general, brokerage and investment banking firms are used by the issuing company or issuer to assist through public offerings and private placements.

Brokerage and investment banking firms spend large sums of money creating, printing and distributing thousands of graphic-rich information to investors. Firms seeking to reduce costs may consider distributing these reports electronically, from computer to computer. Electronic distribution is generally cost effective when compared with hard copy distribution methods. Global computer networks, such as the Internet, enable information to be distributed to a wide range of people at locations around the world.

One of the many advantages of the Internet, particularly the World Wide Web, is that the communication protocols used are non-proprietary, thus enabling end users to access and use the Internet without the need for customized hardware or software. Along with electronic distribution the Internet provides an effective way to provide information to investors.

### SUMMARY OF THE INVENTION

Issuers, brokerage firms and investment banking firms may wish to provide information to investors or users on a controlled basis which is not consistent with the usual openness of the Internet. In particular, the issuers and firms may want to provide information only to those users who are qualified, such as accredited investors in compliance with securities rules in a private offering. Further, the issuers and firms may want to restrict access to certain types of information to certain classes of users. The firms may require that the format of the information provided to one user be different from the format of the same information provided to another user or class of users. Furthermore, the firms and issuers may be required under securities rules to limit users' use of information, such as printing and copying for unauthorized distribution or publication.

The present invention provides a system and method for processing private information requests from a client to a server through a network, such as the Internet. In particular, a server may authorize access to private information to qualified users and limit the use of information.

In one embodiment of the invention, the server provides private offering information to accredited investors. A potential accredited investor (user) requests access to private offering information on the server by using a client device connected to the network. The user accesses the registration form from the server, completes the form, and forwards the registration form to request access to private offering information. From the registration form, accreditation of the user in accordance with securities rules is assured. A password for the client's access to the private offering information is then enabled at the server. The password may be randomly generated and provided from the server to the user by e-mail or other means.

After receiving the registration form from the user, the server may notify the user that the registration form has been received, for example, via electronic mail, facsimile or telephone. The notification may include information regarding when the registration form was submitted, how to contact the administrator for questions relating to the registration process and accessing private offering information, and when the processing is expected to be completed.

A system administrator may assure accreditation of a user from the registration form by contacting a reference provided in the registration form. The references may include people or entities who can confirm the financial status of the user. For example, the user's broker, accountant, banker or attorney may serve as a reference.

Before the private offering information is made available to the user, the user may be required to access a user license agreement from the server. The user completes and forwards the user license agreement, representing that the user is an accredited investor in accordance with securities rules and agreeing to comply with securities rules while accessing the private offering information. In particular, the user agrees not to make any unauthorized copies or prints of the private offering information. The user license agreement also may include an accreditation statement defining accredited investor under securities law.

In another aspect of the invention, when the user requests access to the private offering information, the server returns a cookie containing the password to the client device to provide access to the private offering information from only that client device. To prevent reuse of the password from another client device, the same password cannot be used in a subsequent log-in. The cookie may be set to expire after a set period. Upon the user's request, the administrator may crumble the cookie to prevent access in the event that the user is no longer an accredited investor or has failed to comply with securities rules while accessing the private offering information.

The server also may transmit a message to the client device instructing it to limit unauthorized use, such as copying and printing of the private offering information. In particular, the message includes an instruction to the client device to open a second browser window that does not have any printing features. The message also includes an instruction to the client device to disable key functions of keyboard and mouse devices to limit printing and copying of the private offering information. The second browser window may also be without an address bar to prevent the user from identifying the URL and then accessing the site with another browser window having the disallowed printing and key functions. The message to the browser further includes an instruction to block caching of the private offering information, so that the information cannot be recovered after the second browser window is closed.

The server also may provide offering information to foreign investors. Before accessing the registration form, the user selects a language in which the user wishes to view the registration form and offering information and a country from which the user is investing. In accordance with the selected country's securities rules, accreditation of the user is confirmed and security features are enabled.

Similarly, the server may provide licensing information to potential licensees. The potential licensees may be authorized according to the needs of the licensor and security features may be disabled to allow printing and copying of licensing information. In addition, after logging in from the client device using a password, the authorized potential licensee may use the same password to log in from another device.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a system according to the present invention.

FIG. 2 is a block diagram of the system of FIG. 1.

FIG. 3 is a flow diagram of the registration process according to the invention.

FIGS. 4A and 4B are flow diagrams of the secure area access process according to the invention.

FIG. 5 is a flow diagram of the exchange process according to the invention FIG. 6 is an example of a registration page.

FIG. 7 is an example of a login page.

FIG. 8 is an example of a first browser window, a second browser window and a key function lock message over the second browser window display screen.

FIG. 9 is an example of a private offering page.

FIG. 10 is an example of a contact request form page.

FIG. 11 is an example of a Private Placement Memorandum page

FIG. 12 is a site map of web pages according to the present invention.

### DETAILED DESCRIPTION OF THE INVENTION

A description of preferred embodiments of the invention follows.

Providing private information over a network such as the Internet is difficult because of the inherent openness and lack of control over the Internet. However, private information such as private offerings require a high level of control over access and use of the information to comply with securities rules. In order to provide private offerings in the U.S., companies and firms must comply with U.S. securities rules. In particular, companies and firms need to insure that the private offerings are made only to “accredited investors.” Otherwise, a violation of securities law may be found. Similarly, for foreign offerings of U.S. securities, companies and firms need to insure that any offer or sale of securities is an “offshore transaction” involving a buyer in a foreign country.

In general, companies and firms have been limited to registering potential investors over the Internet. For example, after the registration and authorization of a potential investor, private and foreign offerings are made employing traditional methods such as by mail or hand delivery. Compliance with securities rules and difficulty in controlling access and use by authorized investors have prevented providing private offering information over the Internet.

The system of the present invention enables companies, brokerage and investment banking firms to provide private information, such as private offerings and licensing. The system also enables these companies and firms to provide private information to various types of potential investors, including accredited, sophisticated and foreign investors by providing control over access and use of the private information.

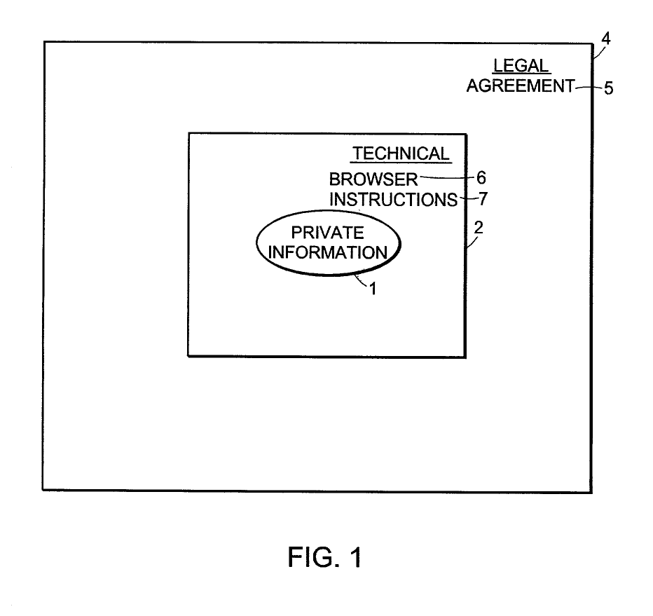

Referring now to the drawings, FIG. 1 is a schematic diagram of a system according to the invention. The system provides legal 4 and technical 2 controls to restrict access and use of private information 1 as web pages over a network, such as the Internet.

The legal 4 and technical 2 controls substantially preclude unauthorized users from accessing the web pages. Further the controls preclude authorized users from making unauthorized use of the web pages, such as copying and printing for redistribution or retransmission.

The legal control 4 includes agreements 5. The agreements 5 include a user license agreement. The agreements are legal documents that are binding and enforceable. The system may require a user to accept a license agreement stating that the user is an authorized investor and will access and use the web pages in compliance with the agreement. Unlike software license agreements, the agreement of the present invention is directed to potential investors and their use of web pages.

When the user is requesting private offering information web pages, the user agrees and provides information that he is an accredited investor. This process restricts unauthorized users from accessing the web pages. In addition, to prevent the user from providing his password to unauthorized users, the user also agrees not to share access to the web pages with unauthorized users. Further, the user agrees not to make unauthorized use of the web pages in violation of securities rules. Any unauthorized copying or printing may be prohibited. The agreement may allow the user to print certain web pages, such as Private Placement Memorandum pages.

In private offerings, the legal control may also include a Private Placement Memorandum including a subscription agreement to restrict access and use of the web pages.

The technical control 2 adds further control to restrict access and use of the web pages having private information. The technical control 2 locks down the web pages 1 to prevent access to the web pages 1 by unauthorized users. For example, the user uses a password to access the web pages providing private offering information. To assure that the password is not distributed to unauthorized user, the technical control 2 includes returning a cookie and flagging of the password at a login to prevent the password from being used by an unauthorized user.

In addition, the technical control 2 locks down the web pages to preclude redistribution or republication of the web pages to unauthorized users. The user may violate securities rules by retransmitting the offering information on the web pages to unaccredited investors by copying and pasting, printing, or providing the URL of the web pages. To prevent such unauthorized use, the technical control includes, but, is not limited to opening a second browser window without printing features, disabling key functions of the keyboard, disabling pull down menu click function of the mouse, and deleting cached web pages after exiting the web pages.

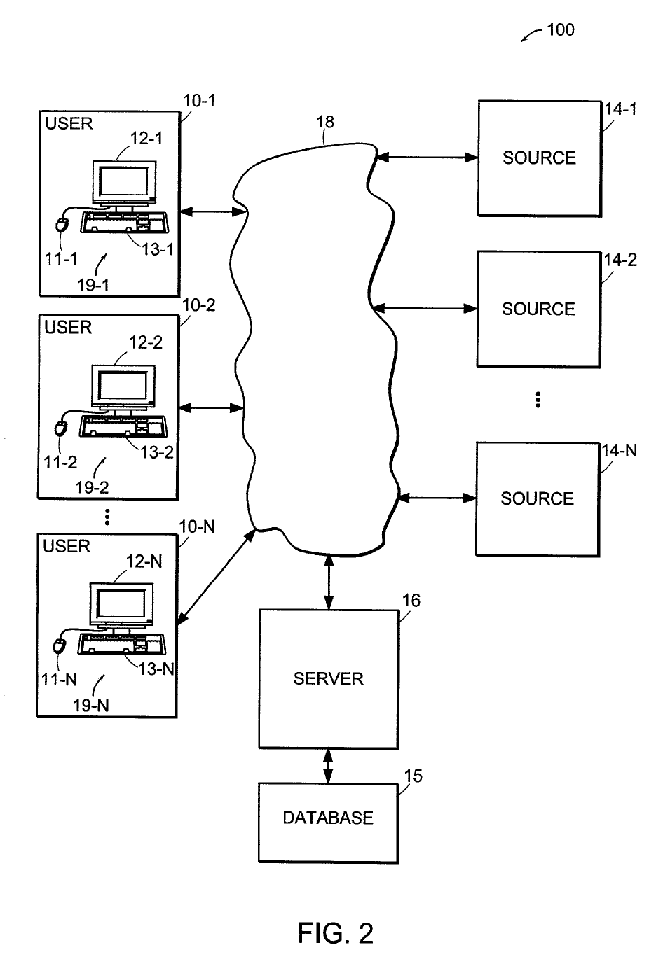

FIG. 2 is a block diagram of the system of FIG. 1. The system 100 includes a plurality of user/clients 10, a plurality of sources 14 and a server 16. The user/clients 10, sources 14 and server 16 are connected over a network 18, such as the Internet. The network also may be an intranet, private network, or other public networks.

The user/client 10 is a person at a client device 19 having connection to the Internet 18. The user is interested in accessing web pages provided by the server 16. In general, the user is a potential investor interested in reviewing securities offerings. However, the user also may be an investor interested in selling his securities. The client device 19 includes a display unit 12, and input units 11 and 13. The client device 19 is preferably a computer of the Personal Computer (PC) type. The keyboard 11 and mouse 13 are coupled to the computer 19 to provide means for inputting data and commands to a processor.

The server 16 provides web pages having private information and has legal and technical controls to limit access to users who are deemed qualified and to restrict the use of web pages, thereby restricting the site to a “private” site. The server may adjust the level of security and confidentiality of the web pages by enabling different legal and technical controls for different types of information. Thus, the server 16 promotes and produces privacy, confidentiality and security when required by business, legal or other concerns.

The server 16 may be a computer having a processor of at least 800 MHZ, 256 MB of random access memory (RAM) and 10 GB of hard drive. An adequate backbone and bandwidth keep the computer 16 on line. An appropriate hosting facility provides suitable security, connectivity, and appropriate computer environment. Both remote and on-site monitoring and technical support are also provided. A Cisco 506 or other firewall system protects the server 16 from hacking or improper access or entry.

The server 16 includes a database 15 for storing information. In the preferred embodiment, the database is a dynamic database storing various types of information from various sources and users/clients. The information stored in the database is accessed by the server 16 and provided as web pages.

The database 15 stores a user list which includes user names of registered users. Once a registered user is authorized, the server generates and writes a password in the user list. In addition, when the user employs the username and password to initially log in, the username and password in the user list are flagged to indicate that the username and password has been used to log in. The flagging of the username and password prevents an unauthorized user from accessing the server using authorized username and password.

The database 15 also stores information regarding users. The user information may include the financial status of a user, i.e, whether the user is accredited under securities rules, recent transactions and offers for sale of securities. The user information is generally gathered from a registration form completed while requesting access to the site and monitoring the user's access and use of the site.

In one embodiment, the database includes a process to facilitate search of information and secure the database. The process may protect the database from hackers and unauthorized users.

The database is a dynamic database enabling different levels of security for different types of information. Depending on web sites or domain name, different levels of security may be required. The level of security for each domain name is stored in the database and enforced on the web pages of the domain name. The level of security and security features for a domain name or web site is stored in the database as a security code. Upon entry to a domain or web site, the security code is read from the database and executed. The administrator may review the security code for a web site and change the code according to the needs of the administrator.

The server and database may be administered by a financial company acting as an intermediary between investors and brokerage and investment firms. The server and database also may be administered by one of the brokerage and investment firms.

In the preferred embodiment, the financial company receives private offering information from brokerage and investment firms over the Internet and stores it in the database. Alternatively, the firms may store private offering information directly to the database using a dedicated private network.

In another embodiment, the server may be administered by the financial company and the database may be provided separately by a brokerage or investment. In addition, one or more databases from various firms and companies may be linked to the server.

The sources 14 of private information depend on the type of information. For private offerings, the sources include issuing companies, potential licensors, brokerage firms and investment banks. For licensing information, the sources include potential licensor.

In one embodiment, the user may be another source of private information. For example, in a secondary market for private securities, the user may be an accredited investor who wishes to sell his private securities.

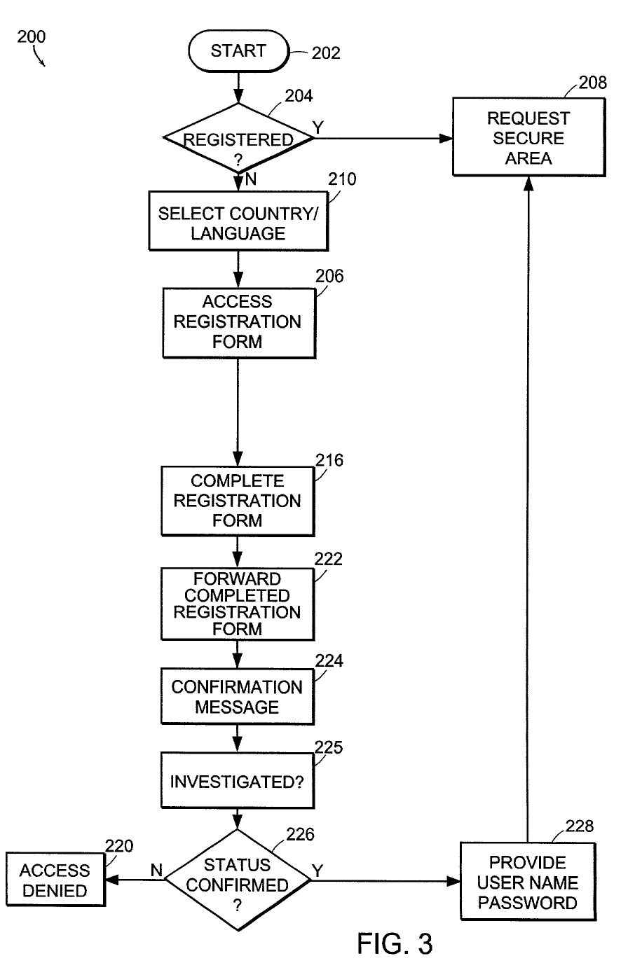

FIG. 3 is a flow diagram of the registration process 200 for potential accredited investor 10 requesting access to private offering information at the server. In particular, the server provides private offering information to accredited investors in compliance with U.S. securities rules.

With reference to step 202 in FIG. 2, the user initially locates a website provided by the server 16 by obtaining the location information, eg. a Uniform Resource Locator (URL), of the website. The URL of the web site providing private offering information is prevented from being entered on search engine directories to maintain privacy and limit access to potential accredited investors. The server instructs crawlers or spiders not to list the site. Since the site is not known to search engines, the user will usually obtain the information through a private source such as a broker or advisor. This location information may be in a variety of forms, such as a URL, a Domain Name Service (DNS) name, or an Internet Protocol (IP) address.

In step 204, the server 16 provides an initial web page, requesting whether the user 10 is registered. If the user 10 is registered, then the user 10 requests the server 16 to enter a secure area 208 having private offering web pages. A user name and password will be required at 208, either through, a login or cookie, as discussed below. If the user is not registered then the user 10 requests the server 16 to access a registration form.

In one embodiment where the server provides private offering information to foreign investors, upon receiving the registration form request, the server 16 may return in step 210 a country and language select page requesting the user 10 to select the country from which the user 10 is investing. The user 10 is also requested to select the language in which the user wishes to view private offering information.

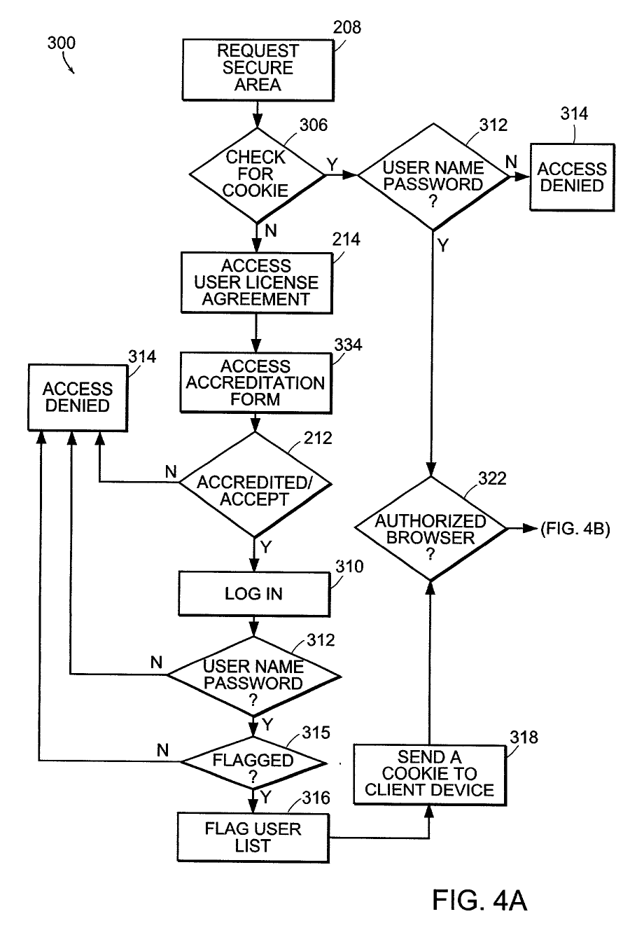

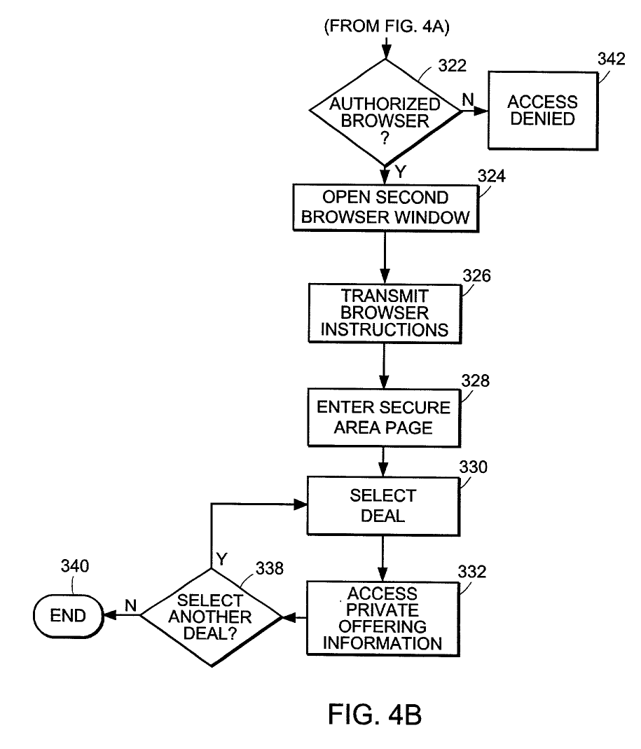

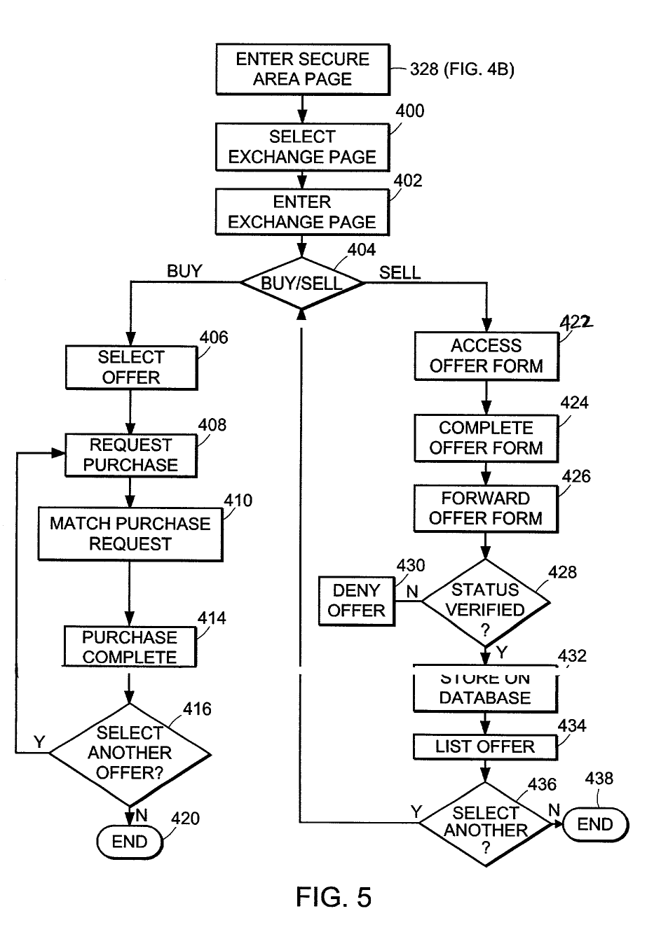

At step 206, the server provides access to the registration form. FIG. 4 is an example of the registration page. The user 10 completes all fields for the registration to be submitted. The registration page includes fields 40 for name, address, phone number, and e-mail address. In addition, reference fields 42 require names and phone numbers of the references. The reference are personal, business, or financial who can confirmed the accredited status of the user. Alternatively, the user might be required to make a declaration of accredited status. The registration form may require further information to confirm accreditation.

Once the registration form is completed in step 216, the user forwards 222 the completed registration form to the server 16. To protect traffic to and from the site, a Verisign™ or similar coded or encrypted system is employed. In addition, web pages sent from the server to the client may be encrypted. Preferably, 128-bit encryption is used.

When the server 16 receives the completed registration form, a confirmation message 224 is returned to the user 10. Preferably, the server 16 transmits an automatically generated electronic mail (e-mail) message. The auto e-mail message confirms the submitted time and when processing is expected to be completed, and advises the registrant to assist the process by informing the reference of the possibility of being contacted. It also provides the potential accredited investor with an e-mail or other address to contact the site password administrator. The message also reminds the user that the accredited investor status has to be confirmed to provide access to the private offering information. Other methods of confirmation include transmitting the message by facsimile and contacting the user by telephone to confirm the receipt of the registration form and process of confirming the accredited investor status.

At the server 16, an administrator or operator of the server confirms the accredited investor status 226 of the user 10 by employing the registration form. In general, one or more references provided in the registration form 42 (FIG. 4) is contacted to confirm the status of the user 10. The references include attorneys, brokers, bankers, and accountants. The accredited investor status also may be confirmed by contacting the user 10 by telephone or fax and requesting further information. A credit report company may be employed to confirm the status. In some cases, the user may already be well known to the company or system administrator and no further investigation is required.

In this embodiment, the definition of accredited investor is provided by the Securities and Exchange Commission (SEC). The SEC allows Private Placement Memorandum or private offerings under rules 504, 505 and 506. These rules also define who may be qualified as accredited investors, as described further herein.

In other embodiments of the invention where the server provides different types of private information, the administrator may set out different requirements for access to the private information. Determining whether the user qualifies depends on a set of factors. Some of the factors include the type of information provided by the server, applicable law, and the country from which the user is accessing the server. For example, if the server is providing private offering information to foreign investors, then the server provides securities rules of the user's country to assure accredition according to its rules. Although requirements are usually set in compliance with governmental rules, the requirements may be tailored to the needs of the administrator to protect the web pages and private information.

After the accredited investor status of the user 10 is investigated 225 and confirmed at 226, the user 10 is notified of approval, disapproval, or further questions preferably by auto e-mail. If approved 228, an auto-generated random password and user name is provided to the user. The user 10 employs the username and password to enter the secure area 208. Either the user name or password can be withdrawn by the site administrator at any time. The auto e-mail message advises the user that the username and password can only be used by the user 10 and the user should not disclose them for other's use. If the registration is rejected, then access to the secured area is denied 220. The user may reply to the auto e-mail to request further consideration or provide additional information confirming the accredited investor status.

FIG. 4A is a flow diagram of the private offering information access process according to the invention. The entry to secure area or private offering information is possible with the user name and password. In general, employing a browser, such as Netscape Navigator or Internet Explorer, the authorized user 10 requests to enter the secure site by selecting the “Enter Secure Area” option from the initial web page at step 208.

In response to the user's request, the server 16 checks the browser 306 at the user 10 to determine whether the user 10 already has a cookie containing the username and password. If the cookie has been set, then the username and password is matched with user names and passwords in the user list at the server to authorize access 308 to the secure area. Otherwise, the user 10 is prompted with a login page.

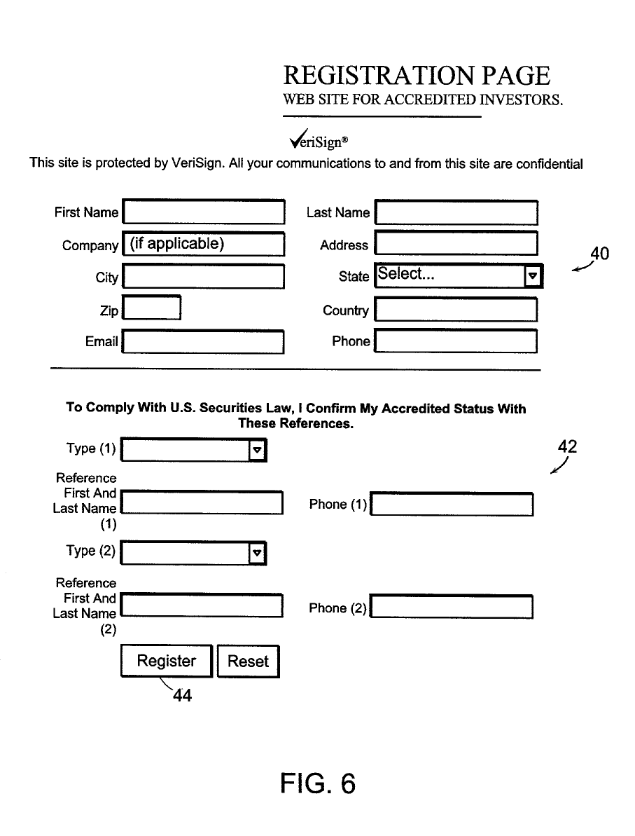

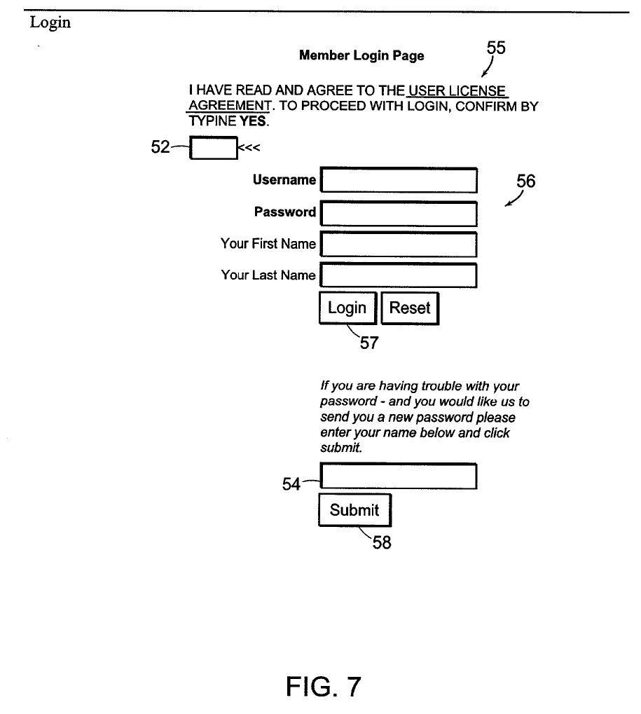

FIG. 7 is an example of the login page. The server sends the login page when it fails to detect a cookie having the username and password. During the login process, the server 16 also requires the user 10 to access an End-User License Agreement (EULA) in step 214. The EULA also comprises an Accreditation Confirmation Statement providing the definition of accredited investor in compliance with securities rules in step 334. In step 212, the server 16 requires the agreement to both the Accreditation Confirmation Statement and the EULA be made by inserting YES in capital letters in an EULA agreement field 52 (FIG. 5).

The server may provide the EULA and Accreditation Confirmation Statement at any time before accessing the secure area. For example, the server 16 may also provide the EULA during the registration process.

The EULA is a legal agreement between the user, an entity represented by the user and the owner of the server and its components, including the web pages. The EULA restricts the user's rights in accessing the web pages provided by the server. The EULA grants the user to view the private information on the user computer only if the user has been provided by the server with a user name and password for the web pages provided by the server as a result of a complete and truthful registration. The user also agrees that he has read the definition of an accredited investor, and truthfully recorded that the user is an accredited investor under U.S. Securities law. In addition, in accordance with the terms of the EULA, the user agrees not to store or install a copy of the web pages on the user computer. The user may not allow the use or distribution of the web pages over any network or the Internet to any computer user that views the web pages which user does not meet the requirements of the accredited investor status. Further, the license for the web pages may not be shared or used concurrently on different computers.

The Accredition Confirmation Statement defines accredited investor in compliance with securities rules. In general, an accredited investor is any natural person whose net worth exceeds $1,000,000.00 or any natural person who had an individual income in excess of $200,000.00 in each of the two most recent years. The accredited investor also includes any company partnership or business trust having assets in excess of $5,000,000, and any bank, savings and loan association, broker, dealer, insurance company, investment company, business development company or small business investment company.

The login page also includes username and password fields 56 to enter the username 56-1 and password 56-2 provided by the server. A new password request field informs the server that the user is having difficulty using the provided username and password.

On the login page, the user 10 enters his or her username 56-1 for the system as well as a password 56-2. The username and password are matched with user names and passwords in the password database 15 to check whether they are valid 312. If the provided username and password are not found in the authorized list then access is denied 314. The user is prompted with the login page stating that the password is not valid. However, the login page also includes a field 54 (FIG. 5) to inform the server that the user is having trouble using the password.

If the username and password are valid, then the server 16 checks the user list to assure that the password has not been used previously to login. The server determines whether the password is flagged 315. If the user list indicates that the password is flagged, then access is denied 314. Otherwise, the server proceeds with the login process and flags the username and password in the user list in step 315. The user list includes user names and passwords that are authorized and indicates whether a password has been used in a login process. In addition, the server creates a cookie and returns it to the client in step 318. The username and password are formed into the cookie so that the user does not have to login again for access to the secure site. Thus, the username and password retrieved from the cookie are matched with the user list. The use of cookies and user list prevents the reuse of the username and password from another device by the user or others.

For example, after logging in using a first client device, if the authorized user 10 attempts to access the private offering information from another device using the same password, then the server provides the login page because it fails to detect a cookie. When the user 10 submits the username and password from the second client device, the server checks the authorized list and reads that the username and password are flagged, indicating that they have been used before. Thus, the server denies access to prevent possible misuse of the username and password by an unauthorized user on a different client device.

If the user requests access from the same client device as the one he initially logged in, then the server detects a cookie having the username and password. The username and password retrieved from the cookie is matched with the user list. If the user list includes the username and password, then the server recognizes that the user is requesting access from the same device and allows access.

This process of cookie issuance rather than subsequent user name and password login prevents viewing of any portion of the site at an unregistered client device since the site pages can only be viewed on the machine that was cookied for the registered user.

Those skilled in the web browser art will appreciate that a cookie is a name/value pair. Typically, the value of the cookie is a string which can be placed in a data structure (e.g., a scalar value, an array reference, or an associative array reference). A cookie is introduced to the client by including a set-cookie header as part of an HTTP response. The web browser at the client then maintains a list of cookies that belong to a particular Web server and returns them when requested.

Those familiar with “cookies” will also appreciate that a cookie has several optional attributes. For example, also, the cookie may include a partial or complete domain name for which the cookie is valid. In accordance with the invention, a cookie may include a “secure” parameter which can be set to “true” to be used only within a secure channel, such as a channel which transmits using the Secure Socket Layer (SSL) protocol. Also, the cookie may include a time/date string that indicates when the cookie expires. The cookie can be for one use only, or for a date certain, or a limited number of days. The cookie may be scripted to be crumbled (deleted or withdrawn from use) after issuance to give total control over the cookie use by the administrator. It can be scripted for Unix, Linux, or MS Windows programs, and preferably be composed as complex script difficult to copy. In addition, in accordance with the invention, the cookie is encoded.

In addition, to prevent an unauthorized user from accessing a secure web page by using the URL of the web page, each web page in the secure area is secured and requires username and password. However, once the authorized user has successfully logged on and received the cookie, the same cookie is retrieved from the client to check the username and password each time the user requests to download a new web page or navigates from one web page to another.

At step 322, the server 16 checks the browser at the client device 19 to determine whether the particular browser software installed on the client 19 is one of the authorized browsers to access the secure area. The server 16 requires the client device 19 to employ an authorized browser to assure that commands and instructions from the server 16 in subsequent steps are followed by the client device 19. For example, an unauthorized browser may download a private offering page without following instructions from the server 16 to limit printing and copy of the page. The authorized browsers include Netscape Navigator 5.0 or above and Internet Explorer 4.0 or above.

If the browser is not an authorized browser, then access is denied in step 342. The server 16 provides a web page informing the user that the client device is using an unauthorized browser and provide a link to download authorized browser software.

FIG. 4B is a flow chart diagram describing the private offering information access process after logging in to the secure area either by using a cookie or login process. The server 16 further restricts the copying or printing of the pages in the secure area by sending a command instructing the client device 19 to open a second browser window to display the pages in step 324.

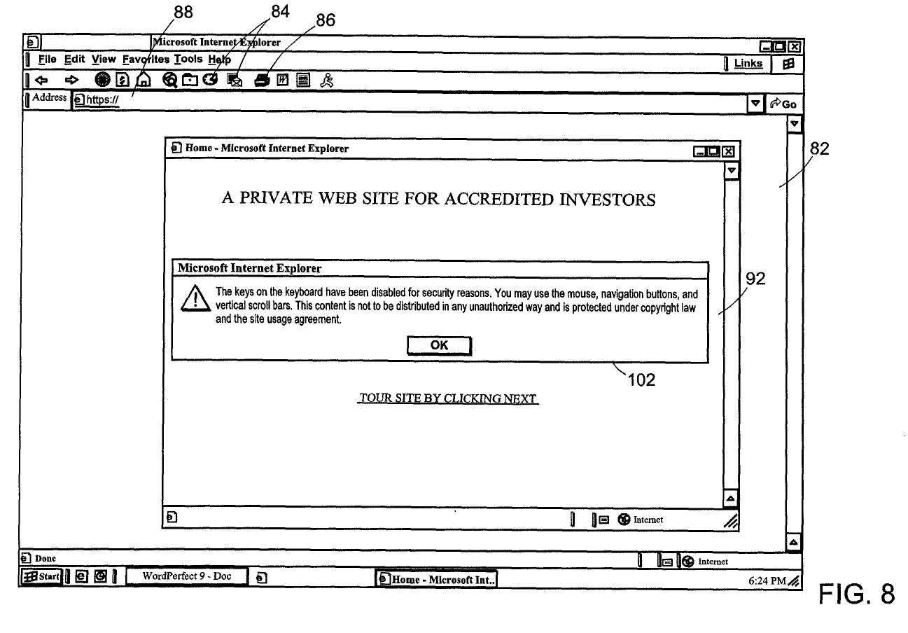

FIG. 8 is an example of a first browser window 82 and a second browser window screen 92 display, and a keyboard lock message 102 over the second browser window. In general, the browser window 82 includes tool bars 84 having a print button 86 and address bar 88. The user 10 may click on “File” at the tool bar 84 to access a drop down menu having a print option. The address bar 88 indicates the URL of the displayed web page. However, as illustrated in FIG. 6, the second browser window 92 does not have tool bars nor address bar to limit copying and printing of web pages. The private offering information pages from the secure area are displayed in the second browser window 92. The second browser window 92 blocks printing of the page by not providing the toolbars 84, and thereby removing the print button 86 and drop down menu having a print option. Further, by removing the address bar 88 in the second browser window 92, the URL of the displayed web page is blocked. As a result, the user 10 is prevented from noting the URL and accessing a web page using the URL in another browser window having toolbars and print options.

At step 326, the server sends additional commands to the client browser to limit copying and printing of the pages. One of the commands instructs the browser to disable the key functions of external input devices attached to the computer. The external input devices are any devices being able to input a command to the computer to print or copy and paste, such as the keyboard and mouse. The key functions include printing, copying and pasting using the keys on the keyboard. The key functions also include highlighting, copying and pasting, and pulling down a sub-menu having a print option using the mouse. Other input functions to view the pages, such as navigation button and vertical scroll bars, are not disabled. For example, the keys of the keyboard and a right-click for sub-menu of the mouse are disabled and cannot be used while displaying a web page.

As illustrated in FIG. 8, when the user 10 tries to print or copy a web page using the keyboard or mouse, the server 16 displays a keyboard lock message 102 indicating that the keys on the keyboard have been disabled for security reasons. The user is reminded that the web page is not to be distributed in any unauthorized way, and is protected under copyright law and the site usage agreement.

In addition, the commands may include an instruction to hide the private information and show a grey display screen when the cursor moves outside of the second browser window. This feature may be used to further limit copying or printing of the private offering web pages.

The following Javascript code sent to the client browser is used to implement disabling of keys on the keyboard and sub-menu click of the mouse:

var alertmsg = ‘The keys on the keyboard have been disabled for security
reasons.’ +

‘You may use the mouse, navigation buttons,
and vertical scroll bars.’ +
‘This content is not to be distributed in any unauthorized way, and’ +
‘is protected under copyright law and the site usage agreement.’
//Wrong browser test
if((navigator.appName != “Microsoft Internet Explorer”)

&& (navigator.appName != “Netscape”)){
alert(‘You must use either Microsoft's Internet Explorer ’ +

‘or a Netscape browser. Some versions of AOL might ’ +
‘not be recognized as a suitable browser.’)

window.close()

}
//Wrong browser version test
if(window.parseInt(navigator.appVersion) < 4){

alert(‘You must use browser version 4.0 and up in order ’ +

‘to use the site’)

window.close()

}
//Mouse clicking stop IE

function click(e) {

if (document.all) {
if (event.button==2||event.button==3) {
alert(alertmsg)
return false;
}

}

//Mouse clicking stop NN

if (document.layers) {
if (e.which == 3) {
alert(alertmsg)
return false;
}

}

}

if (document.layers) {
document.captureEvents(Event.MOUSEDOWN);
document.captureEvents(Event.KEYPRESS);
}

//Key pressing stop
function Keyclick(e) {

//alert(window.event.keyCode)

alert(alertmsg)

return false;

}
//Erase clipboard IE only
function clearClipboard(){

window.clipboardData.clearData()

}

//Functions that do the work - scroll out of view
function MouseLeave(){

window.scroll(0,1800)
}

//- scroll into view
function MouseEnter(){

window.scroll(0,0)
}

//Mouse leaves browser window
document.body.onmouseleave = MouseLeave
//Mouse enters browser window
document.body.onmouseenter = MouseEnter

//Fire all events
document.onmousedown=click;
document.onkeypress=Keyclick;
document.onkeydown=Keyclick;
document.onmousemove = clearClipboard;
window.onblur = clearClipboard;

The code also disables the “Print Screen” key. Even when the keys of the keyboard are disabled, the user may copy and paste the web pages by using the “Print Screen” key. If the user 10 presses the “Print Screen” key, then the client device 19 does not print the screen because the key is disabled by the above script. However, when the key is pressed, the computer also makes a copy of the screen and stores it in memory or clipboard. In addition, since the key functions are locked only in using the second browser window, the user 10 may move the cursor to another application window such as Microsoft Word or Corel WordPerfect and use the application to paste the web pages from the memory or clipboard. To prevent the user 10 from copying and pasting web pages using “Print Screen” key, the server 16 also sends a command to clear the clipboard when the user moves the cursor using the mouse. The clipboard is also cleared when the second browser window is not the active browser.

The server 16 also sends a command instructing the client 19 not to cache the downloaded pages to prevent copying or printing of downloaded pages after the second browser window is closed. In general, the client device 19 caches web pages downloaded by its browser in memory. Since the downloaded pages are cached in memory, the user may access the downloaded web pages after the browser is closed. To prevent this, the server 16 sends a command to the browser to delete or destroy downloaded pages stored in memory when the browser window is closed.

After transmitting messages to prevent printing and copying, the server 16 sends a secure area home page to the second browser window at step 328. The secure home page may display a selection of private offerings. At step 330, the accredited investor 10 selects a private offering in which he is interested. At step 332, the server provides the requested pages and thereby allow access to the private offering information.

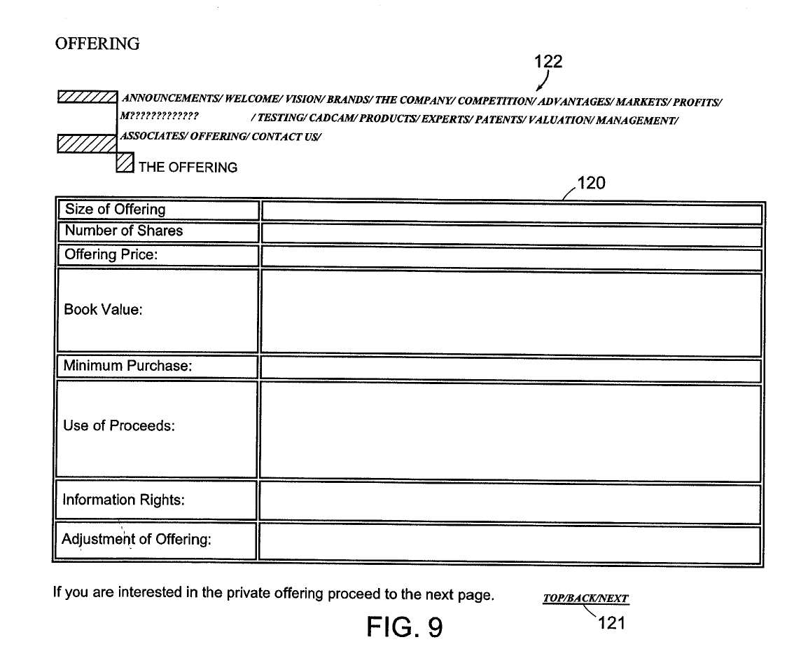

The pages include various information about a company issuing the private offering, such as management, products, assets, financial status, contact and offering information. FIG. 9 is an example of an offering page. The offering page includes information 120 about the size of offering, number of shares, offering price, book value, minimum purchase, use of proceeds, information rights, and adjustment of offering. Each page also 100 includes links 122 to other related pages to allow ease access to information regarding the private offering. The accredited investor 10 may click onto any of the links to access that page.

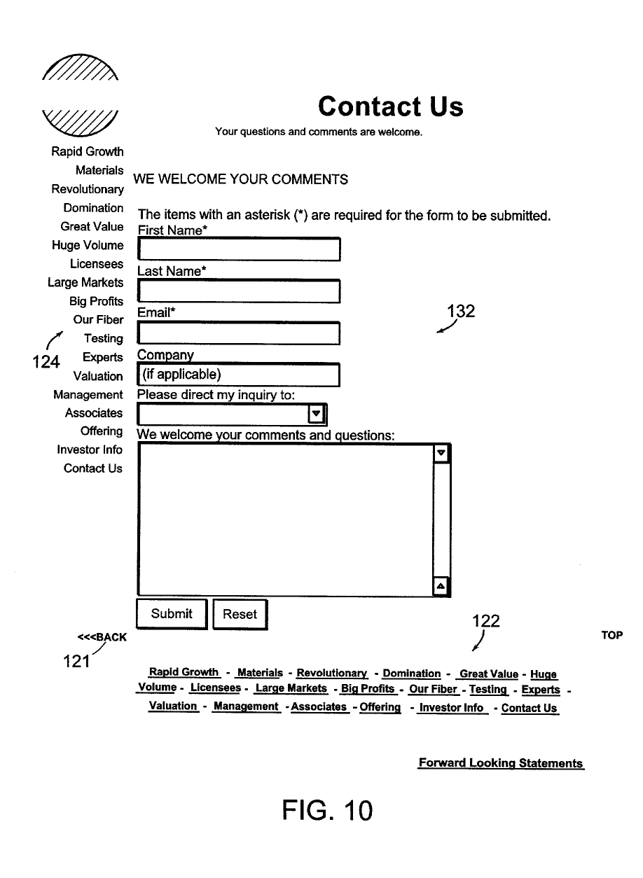

FIG. 10 is an example of a contact request form page. Each private offering includes a contact page for further information to be provided to the accredited investor, including preferences for the mode of contact. Similar to the offering page, the contact request page has links 122 to other related pages.

If the accredited investor 10 wishes to review other private offerings, then the accredited investor selects to view other private offerings at step 338 and is prompted back to step 330. Otherwise, the accredited investor 10 ends the session at step 340 by closing the second browser window.

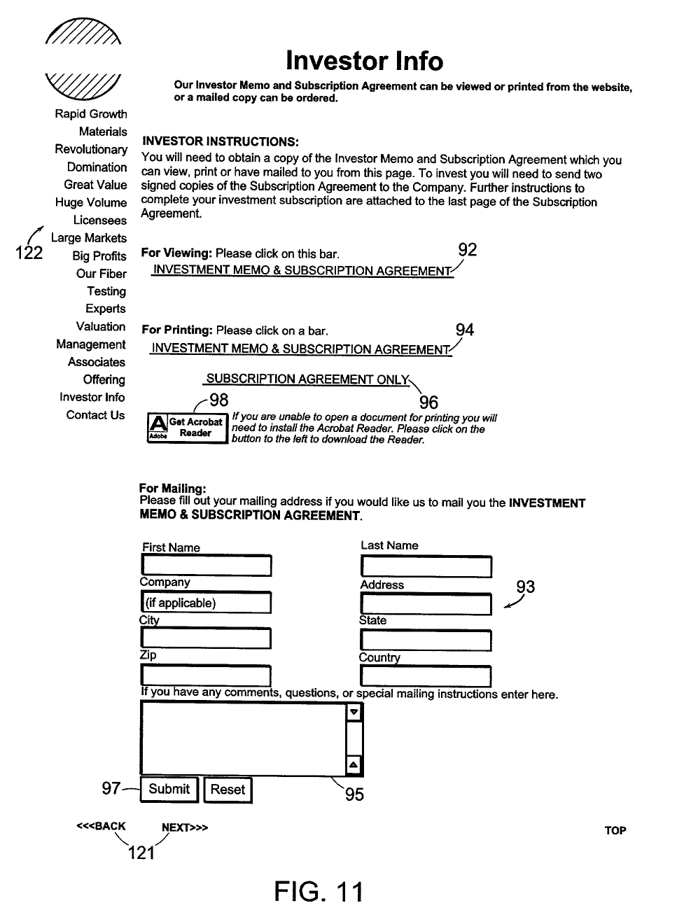

FIG. 11 is an example of Private Placement Memorandum and Subscription Agreement page. From this page, the accredited investor may obtain a copy of the Private Placement Memorandum (PPM) and Subscription Agreement. The server allows the accredited investor to view the PPM and agreement by clicking on the view link 92 or print by clicking on the print link 94 and 96. In addition, the accredited investor may fill out request-by-mail fields 93 and click submit button 97 to request the PPM and agreement by mail. The PPM request page also includes a comment field 95 to submit comments and questions to the administrator.

The web pages providing private offering information are created with HTML and Java Script that may invoke or link to Flash™ animations, AVI, MPEG, WAV, JPEG, or any other types of multimedia audio, video, text, HTML, or image file. Thus, the private offering information may be provided in Flash™ animations or other multimedia presentations. In addition, other software may be used to provide web casting and videoconferencing.

For example, for specific users, the web pages may be personalized to enable video conferencing with the management of the issuing company or a message board providing further information regarding a private offering. The message board may include text messages and schedule of offering events. In general, the messages are messages posted for an issuer or offeror of private securities from accredited investors. The administrator may control the messages so that only the messages from currently logged on users are shown. In addition, the issuer or offeror may also post messages. The event posting includes posting of upcoming private offerings or conferencing scheduling. In general, the administrator posts events. E-mail notifications may be sent to selected investors for message and event posting.

In addition, when the user enters the secure area, the user may be prompted to broadcast web pages before accessing private offering pages. The broadcast web pages include multimedia playback features including streaming audio and video. The information presented on the broadcast web pages is generally related to the companies and the companies' offerings.

FIG. 5 is a flow chart diagram of another embodiment of the present invention describing the exchange process of private securities. Under the U.S. securities rules, the accredited investor may offer for sale his securities purchased in non-public transactions from issuers. Similar to private offerings, the accredited investor is required to offer for sale or sell his private securities to accredited investors in compliance with securities rules. Therefore, the present invention may be used to provide an exchange for secondary transactions of private securities.

As described above, the accredited investor is allowed to enter the secure area page at step 328 (FIG. 4B). At step 400, the accredited investor selects and requests for the exchange page. Upon the accredited investor's request, the server provides the exchange page at step 402. The accredited investor selects to either buy or sell private securities in step 404.

If the accredited investor wishes to buy private securities in a secondary transaction, then the server provides a web page having one or more offers for private securities. Since the status of accredited investor has been confirmed and the client device authorized for proper use from the registration and login processes, the administrator does not need to reconfirm status and authorize client device. However, the server may provide a different web site for the exchange of private securities. In this case, the server may confirm and authorize the financial status of the investor through above described registration and login processes.

In step 406, the accredited investor selects an offer in which he is interested. The accredited investor requests to purchase in step 408. The accredited investor may complete a purchase form indicating the number of shares he wishes to purchase and payment information. The purchase request form may be similar to the Subscription form in private offerings.

In step 410, the server receives the purchase request and matches with one or more private securities offers to complete the deal in step 414. In step 416, the accredited investor may select another offer and be prompted back to step 408. Otherwise, the accredited investor ends his session in step 420.

If the accredited investor selects to sell private securities in step 404, then the investor proceeds to access an offer form page in step 422. The offer form may require the investor to provide various information regarding the private securities such as the date of purchase and how many shares the investor wishes to offer for sale. The form may require further information to assure compliance with securities rules.

In step 424, the accredited investor completes the form and forwards it to the server in step 426. In step 428, the status of the accredited investor and private securities is confirmed to assure compliance with securities rules. For example, one of the requirements is that the accredited investor has purchased the private securities at least one year before the date of sale. If the status is not confirmed and a transaction violates the securities law, then the offering of private securities is denied in step 430. Otherwise, the administrator takes the offer and stores in the database for access to accredited investors interested in purchasing them.

The server lists the offer on the exchange page in step 434. The accredited investor may select to sell or buy other private securities by selecting another deal in step 436. Otherwise the session ends in step 438.

It is understood that the exchange page may be provided on a different web site than the secure area page. In addition, the accredited investor may enter the exchange page without completing the registration and login processes required to enter the secure area for private offering information. In particular, the registration and login processes may not be required when the accredited investor is interested in selling his private securities. As described above, the offer form may include similar fields as the registration page to assure that the status of the investor and his private securities.

In further embodiment, the system may allow accredited investors to purchase private offerings after reviewing private offering web pages over the Internet. The server may receive a purchase request from the investor and process the purchase request. The server then updates the database to store the transaction information.

In another embodiment, the server 16 may auto-generate and send e-mail messages to specific accredited investors 10 informing about new private offerings. The e-mail messages may include the URL and corresponding username and password to a personalized web site having private offering information.

In one embodiment of the present invention, the server 16 provides licensing information to a potential licensee 10. The potential licensee 10 accesses, completes and forwards a registration form to the server 16. The registration form and its requested fields depend on the requirements of the licensor 14. Since the licensing information is not regulated by securities rules, the server may allow the potential licensee 10 to use a username and password from one or more devices. In addition, the server may send messages allowing the potential licensee 10 to make copies and print the licensing information.

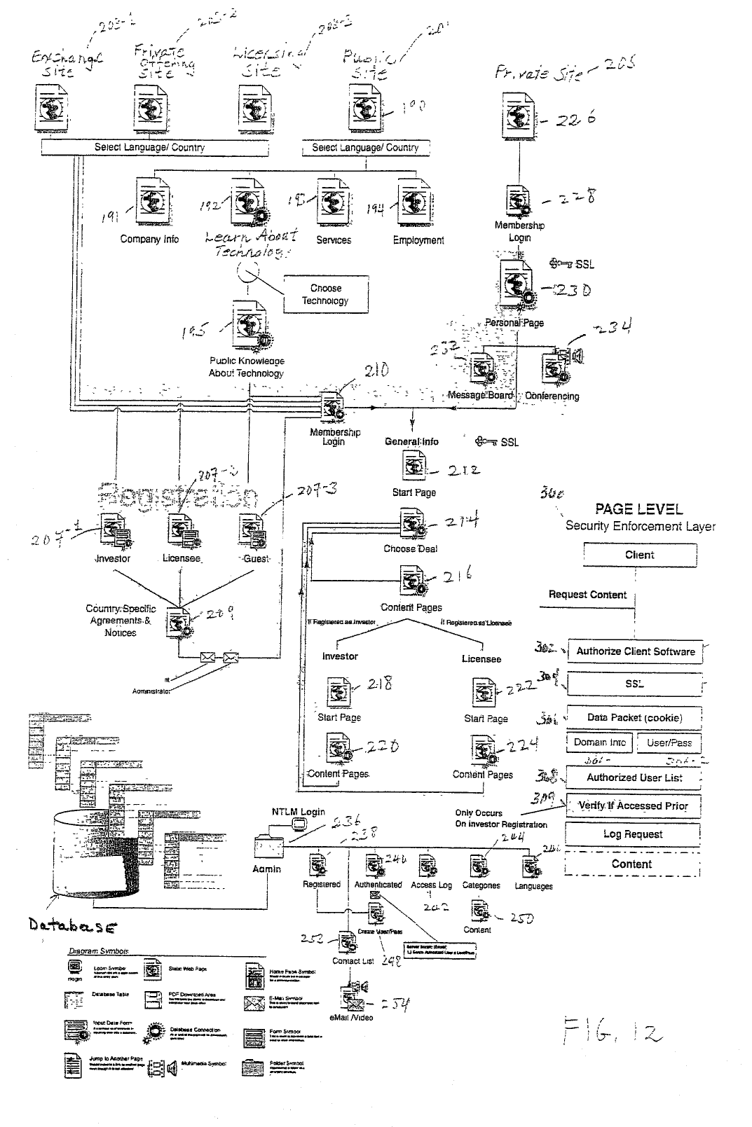

FIG. 12 is a site map of web pages according to the present invention. The site maps are generally representative of independent web pages for both public/member site users and the administrator.

Security Model

Functional security is the interaction that takes place between the user and the system. Functional security for the site includes membership enrollment, private membership site, registered user content, and encryption.

Security business rules are stored in the database and enforced on the page level. A table is to be created to list the necessary layers of security. Depending on entry point domain a different level of security may be required.

1. Database Schema of Security Model

a. TABLE: DomainSecurity

i. DomainName (Varchar)

b. TABLE: DomainSecurityLayerRules—linking table

i. DomainSecurityID (Foreign Key)

ii. DomainSecurityLayerRulesDetailID (Foreign Key)

iii. SortOrder (Integer)

c. TABLE: DomainSecurityLayerRulesDetail

i. SecurityLevelName (Varchar)

ii. ExecuteScriptCode (Text)

Security model rules are stored in the database, and execute code from the database pertaining to entry point domain. For the flexibility of the system, the administration staff may examine the best security model for each of the entry point domains and allow the changing of the security model accordingly.

Membership Enrollment

Upon entering site, the user is presented with choice of language—upon clicking language-desired user enters an SSL (secure socket layer) encryption algorithm, which encrypts the data from the client to the server. The user is then prompted for a user/pass to enter site. If user does not have user/pass, a link is provided to sign up for a membership.

Clicking on the “signup for a membership” link tales them to the registration page. This page has the fields specified as well as instructions for that given page (if any).

Upon filling out the registration form the user is required to submit the information by pressing the submit button. They are then directed to a “thank you” page, which has additional instructions as to processing of registration procedure. There may be different procedures depending on type of user.

Private Membership Site

Upon entering site user is presented with choice of language—upon clicking language-desired user may enter into a SSL (secure socket layer) encryption algorithm, which encrypts the data from the client to the server. The user is then prompted for a user/pass to enter private site. If user does not have user/pass a no link may be provided. The user is required to have the proper security credentials before entering private site.

Registered User Content (Page Level Security Flow), and Encryption

Referring to Page Level Security Enforcement Layer 300 in FIG. 12, user content is protected as per follows:

a. Authorized client software pertaining to browser version and software manufacture 302.

b. SSL encryption between client and server 304

c. Validity of cookie existence 306

i. Containing domain name 306-1

ii. Containing user/pass 306-2

d. Verify user in database 308

i. User and password match

ii. Verify if accessed prior 309

e. Audit access

Encryption

Encryption is a process that protects information as it moves from your computer to the Web sites computer that you are communicating with, and back again. By using a complex mathematical process, an encryption algorithm, the information is encoded before it is sent and decoded with the use of a secret “key” when it is received. Without this key, the information is undecipherable.

Computers use a binary number that is usually 40- to 128-bits in length as the “key”. The larger the key, the more difficult it is to break and decipher the message in transit.

Encryption is used whenever the user enters a secured web page such as the members' area. There is a closed lock icon in the lower portion of your Netscape or Microsoft browser whenever the user is on a secure web page. When the user begins an online session with a secured site, the computer and the host system agree on a random number that serves as the key for that session. Every time the user accesses that Web site, the key is changed. The level of encryption that the user chooses for the web browser dictates the length of that number. Most web browsers use either 40- or 128-bit encryption. 128-bit encryption is 300 septillion times stronger than standard encryption. Browsers with standard 40 and 56-bit encryption make available billions of possible keys. 128-bit encryption means that there are 2 to the power of 128 possible keys to your information and every time you access a 128-bit encrypted site the key is changed. 128-bit SSL encryption has never been broken and according to RSL Labs, it would take a “trillion-trillion years” to crack the code using today's technology.

Public Site 201

Company Info

Learn About Company's Technologies

Services

Employment

Login

Members Site 203

Company Info

Learn About Company's Technologies

Services

Employment

Login In/Out

Dynamic List of Content Pages listed in Drop down box—(listingsmay depend on database page references for that user)

Private Site 205

Public Site

Login In/Out

Private Home Page

Message Board

Conferencing

Dynamic List of

Page Specifications

Public Site 201

1. Home Page 190

i. This page may have a centerpiece graphic (to be designed) with a small description of what Company does.

ii. This page may have a design, which is called the “parent page” and will not carry throughout the site other than the color scheme.

iii. Flags represent the languages available on the site.

1. Upon clicking on the flag the page refreshes to the same page as an addition displays navigational links in the appropriate language as well as display the login fields (user/pass). Underneath the login an additional link takes them to the Guest registration page if user is not already registered with the site as a Guest.

2. Languages is determined from the database.

a. Database Schema

TABLE
[Languages]

| | | |
|---|---|---|
| i. | LanguageName | (Varchar) |
| ii. | LanguageFlag | (Varchar) |

2. Company Information 191

i. This page utilizes same template for child pages for the public site.

ii. This page includes information about the history and general information about the company.

3. Learn About Company's Technologies 192

i. This page utilizes same template for child pages for the public site

ii. Dynamic content is displayed on this page from information stored in the database pertaining to the current company offerings.

1. Dynamic display type: List display w/content

a. Database Schema

TABLE
[Technologies]

| | | |
|---|---|---|
| i. | Headline | (Varchar) |
| ii. | ShortDescription | (Varchar) |
| iii. | GroupTypeID | (Foreign Key) |

b. Business Logic

i. Information is only displayed if GroupTypeID matches ID for the given page allowing for display of information.

2. Headline is a click able link to continue to Public Knowledge About Technology

4. Services 193

i. This page utilizes same template for child pages for the public site

ii. This page includes services that Company provides to its clients.

5. Employment 194

i. This page utilizes same template for child pages for the public site.

6. Public Knowledge About Technology 195

i. This page utilizes same template for child pages for the public site.

ii. Dynamic content is displayed on this page from information stored in the database pertaining to the current offerings.

1. Dynamic display type: Paragraph text

a. Database Schema

TABLE
[Technologies]

| | | |
|---|---|---|
| i. | PublicLongDescription | (Text) |
| ii. | Below paragraph text - a link to register as guest | |
| | may be showing. | |
| iii. | If cookie presence from site is detected a continue | |
| | link is showing to allow the person to enter secure | |
| | content area for additional information about | |
| | technology. If cookies user/pass fails one of the | |
| | security layers user is directed to login page. | |
| iv. | User with Guest permissions only sees the general | |
| | information about technology. | |

7. Register as Guest 207-3

i. This page utilizes same template for child pages for the public site

ii. User is presented with a form to fill out to register as a guest

1. Form fields

a. First Name (Varchar)-Required

b. Last Name (Varchar)-Required

c. Address (Varchar)-Required

d. City (Varchar)-Required

e. State (Varchar)-Required

f. Zip (Varchar)-Required

g. Country (Varchar)-Required

h. Email (Varchar)

i. Comments (Varchar)

2. Database Schema

TABLE
[RegisteredUsers]

| | |
|---|---|
| a. | Above Form fields match fields in database. |
| b. | GroupTypeID - populated as per the appropriate |
| | GroupTypeID |
| c. | Database table for this registration posting is |
| | [RegisteredUsers] table. |

3. Email

a. Email 1 is sent to the administrator

b. Email 2 is sent to the user.

iii. Submitting form takes user to Country Specific Agreement and Notices for additional information

8. Country Specific Agreements & Notices 209

i. This page utilizes same template for child pages for the public site

ii. User is presented with information pertaining country specific agreements or notices.

1. Dynamic display type: List display w/content

a. Database Schema

TABLE
[AgreementsNotices]

| | | |
|---|---|---|
| i. | Title | (Varchar) |
| ii. | LongDescription | (Text) |
| iii. | MustAgreeTo | (Boolean) |
| iv. | CountryID | (ForeignKey) |

b. Form Fields

i. Checkbox

1. If MustAgreeTo field is set to true it is required that the user marks this field “I have read the “[title of document]” and agree to the terms and conditions set forth

2. User is presented with a continue button on the bottom of the page which submits the information into the user registration table along with the users information.

2. Input posting to database

a. All Agreements and Notice approvals are stored in the RegisteredUsersAgreementsNotices table.

b. Database Schema

TABLE
[RegisteredUsersAgreementsNotices]

| | | |
|---|---|---|
| i. | AgreementsNoticesID | (Foreign Key) |
| ii. | RegisteredUserID | (Foreign Key) |
| iii. | UserAgreed | (Boolean) |
| iv. | Upon filling out form and submitting user is | |
| | redirected to thank you page. | |

9. Membership Login 210

i. Membership login is only used if user has no existence of cookie or authenticated user/pass. User is then directed to a SSL secure connection presented with the user/pass fields to login.

1. Query Database

TABLE
[AuthenticedUsers]

| | |
|---|---|
| a. | UserName |
| b. | Password |

2. Upon authentication user is directed to—Start Page for the general information section. This section is a secure area and utilizes the security model described herein.

2. Membership Site 203

Intended for focus groups, which would use separate entry points rather than the public site. All uses entering thru the public site are only allowed to register as guests. Users are predetermined to register as specific site user by way of the entry point domain. Upon entering—user has only one direction to move and is not allowed to register as anything else but what is dictated in the business rules programmed into the logical software application.

10. Exchange Home Page 203-1

i. Page carries a unique look and feel pertaining to its own ideal characteristics.

ii. Site Intent

11. Private Offering Home Page 203-2

i. This page has a centerpiece graphic with a small description of what this page does.

ii. This page has a design, which is called the “parent page”

iii. Flags represent the languages available on the site.

1. Upon clicking on the flag the page refreshes to the same page as an addition displays navigational links in the appropriate language as well as display the login fields (user/pass). Underneath the login an additional link takes them to the Investor registration page if user is not already registered with the site as an Investor.

2. Languages is determined from the database.

a. Database Schema

TABLE
[Languages]

| | | |
|---|---|---|
| i. | LanguageName | (Varchar) |
| ii. | LanguageFlag | (Varchar) |

12. Licensing Home Page 203-3

i. This page has a centerpiece graphic with a small description of what this page does

ii. This page has a design, which is called the “parent page”.

iii. Flags represent the languages available on the site.

1. Upon clicking on the flag the page refreshs to the same page as an addition displays navigational links in the appropriate language as well as display the login fields (user/pass). Underneath the login an additional link takes them to the Licensee registration page if user is not already registered with the site as a Licensee.

2. Languages is determined from the database.

a. Database Schema

TABLE
[Languages]

| | | |
|---|---|---|
| i. | LanguageName | (Varchar) |
| ii. | LanguageFlag | (Varchar) |

13. Investor Registration Page 207-1

i. This page utilizes same template for child pages for the private offering site

ii. User is presented with a form to fill out to register as an Investor.

1. Form fields

a. First Name (Varchar)-Required

b. Last Name (Varchar)-Required

c. Address (Varchar)-Required

d. City (Varchar)-Required

e. State (Varchar)-Required

f. Zip (Varchar)-Required

g. Country (Varchar)-Required

h. Phone (Varchar)

i. Email (Varchar)

j. FinancialName1 (Varchar)-Required

k. FinancialType1 (Varchar)-Required

l. FinancialPhone1 (Varchar)-Required

m. FinancialName2 (Varchar)-Required

n. FinancialType2 (Varchar)-Required

o. FinancialPhone2 (Varchar)-Required

2. Database Schema

TABLE
[RegisteredUsers]

| | |
|---|---|
| a. | Above Form fields match fields in database. |
| b. | GroupTypeID - populated as per the appropriate |
| | GroupTypeID |
| c. | Database table for this registration posting is |
| | [RegisteredUsers] table. |

3. Email

a. Email 1 is sent to administrator

b. Email 2 is sent to user who has registered.

iii. Submitting form may take user to Country specific agreement and notices page

14. Licensee Registration Page 207-2

i. This page utilizes same template for child pages for the Licensing site

ii. User is presented with a form to fill out to register as a Licensee.

1. Form fields

a. First Name (Varchar)-Required

b. Last Name (Varchar)-Required

c. Address (Varchar)-Required

d. City (Varchar)-Required

e. State (Varchar)-Required

f. Zip (Varchar)-Required

g. Country (Varchar)-Required

h. Phone (Varchar)

i. Email (Varchar)

ReferenceName1 (Varchar)-Required

k. ReferenceEmail1 (Varchar)-Required

2. Database Schema

TABLE
[RegisteredUsers]

| | |
|---|---|
| a. | Above Form fields match fields in database. |
| b. | GroupTypeID - populated as per the appropriate GroupTypeID |
| c. | Database table for this registration posting may be [RegisteredUsers] |
| | table. |

3. Email

a. Email 1 is sent to administrator

b. Email 2 is sent to user who has registered.

iii. Submitting form may take user to Country specific agreement and notices page

15. Country Specific Agreements & Notices 209

i. This page utilizes same template for child pages for the current site for which its being displayed

ii. User is presented with information pertaining country specific agreements or notices.

1. Dynamic display type: List display w/content

a. Database Schema

TABLE
[AgreementsNotices]

| | | |
|---|---|---|
| i. | Title | (Varchar) |
| ii. | LongDescription | (Text) |
| iii. | MustAgreeTo | (Boolean) |
| iv. | CountryID | (ForeignKey) |

b. Form Fields

i. Checkbox

1. If MustAgreeTo field is set to true it is required that the user mark this field “I have read the “[title of document]” and agree to the terms and conditions set forth.

2. User is presented with a continue button on the bottom of the page which submits the information into the user registration table along with the users information.

3. Input posting to database

a. All Agreements and Notice approvals are stored in the RegisteredUsersAgreementsNotices table.

b. Database Schema

TABLE
[RegisteredUsersAgreementsNotices]

| | | |
|---|---|---|
| i. | AgreementsNoticesID | (ForeignKey) |
| ii. | RegisteredUserID | (Foreign Key) |
| iii. | UserAgreed | (Boolean) |

iii. Upon filling out form and submitting user may be redirected to thank you page.

16. Membership Login 210

i. Membership login is only be used if user has no existence of cookie or authenticated user/pass. User is then directed to a SSL secure connection presented with the user/pass fields to login.

1. Query Database

TABLE
[AuthenticedUsers]

| | |
|---|---|
| a. | UserName |
| b. | Password |

2. Upon authentication user is directed to Start Page for the general information section. This section is a secure area and utilizes the security model described herein.

3. Secure Content Pages

All secure pages employ the security model described herein. The database provides security code execution for the given entry point domain.

17. General Info

i. Start Page 212

1. This page utilizes same template for child pages for the current site for which it is being displayed.

2. A dynamic page link list is displayed on this page from information stored in the database pertaining to the current offering.

3. Dynamic display type: Links to content references from within the database.

a. These references may be the page URL and ID of where the data is held. And the particular data being extracted depends on user language and user registration privileges.

4. Below paragraph text—a link to register as guest may be showing.

5. If cookie presence from site is detected a continue link may be showing to allow the person to enter secure content area for additional information about technology. If cookies user/pass fails one of the security layers user may be directed to login page.

6. User with Guest permissions may only see the general information about technology.

ii. Choose Deal 214

1. This page may not be a page but actually a drop down box for the user to choose what deal they would like information about.

2. User is displayed the current deals that are assigned to that class of user.

3. The drop down may display on all pages in the secure area, which are accessible at any time from the user.

iii. Content Pages 216

1. This page may utilize same template for child pages for the current site for which it is being displayed.

2. Dynamic Navigation:

a. Depending on user class this page may display a dynamic list of content page in reference to the current deal from which is presented

i. The general list of links may display first if extended permission are present database may display all pages pertaining to user.

b. It may be sorted from the database and sort the page order

c. Visual display of navigation is as per page.

i. It may be the responsibility for the programmer to present the navigation as per the comp dynamically.

d. Each page user is on may light up the navigation link to indicate what page is currently being displayed.

e. Database Schema

TABLE
[Content]

| | | |
|---|---|---|
| i. | ContentName | (Text) |
| ii. | UserClassID | (Foreign Key) |
| iii. | SortOrder | (integer) |

3. Page Display

a. This template page may be dynamically generated form the content stored in the database.

b. Content may be in the current language from user selection from home page

c. Paragraph end may have next and back navigation

i. Clicking Next takes user to the next page in sort order

1. If user is on the last page the “next” link disappears.

ii. Click Back may take user to previous page in sort order

1. If user is on the first page the “back” link disappears

d. Information on this template may uphold the security model listed above.

i. If at any time one of the security layers are breached the user may be directed to membership login.

4. Content Control

a. Content for this template may display the general information about deal or technology. If user has extended permissions beyond the general class. User maysee additional links on navigation display for the appropriate content pages for their class.

5. Database Schema

TABLE
[Content]

| | | |
|---|---|---|
| a. | Content | (Text) |
| b. | UserClassID | (Foreign Key) |

6. May be in the current language chosen from the entry point of the family of sites and extract content in the appropriate language.

18. Investor

i. Start Page 218

1. This page may utilize same template for child pages for the current site for which it is being displayed

2. Page may display first page in sort order for the intended Investor user class.

3. May be in the current language chosen from the entry point of the family of sites and extract content in the appropriate language.

ii. Content Pages 220

1. This page may utilize same template for child pages for the current site for which it is being displayed

2. This page template may represent same instructions but only display the Investor information.

3. May be in the current language chosen from the entry point of the family of sites and extract content in the appropriate language.

19. Licensee

i. Start Page 222

1. This page may utilize same template for child pages for the current site for which it is being displayed

2. Page may display first page in sort order for the intended Licensee user class.

3. May be in the current language chosen from the entry point of the family of sites and extract content in the appropriate language.

ii. Content Pages 224

1. This page may utilize same template for child pages for the current site for which it is being displayed

2. This page template may represent same instructions but only display the Licensee information.

3. May be in the current language chosen from the entry point of the family of sites and extract content in the appropriate language.

4. Private Site 205

20. Private Site Home Page 226

i. This page may have a centerpiece graphic with a small description of what company does.

ii. This page may have a design, which is called the “parent page” comp and may not carry throughout the site other than the color scheme.

iii. May include name of company or individual from whom this site is presented for.

iv. Flags may represent the languages available on the site.

1. Upon clicking on the flag the page refreshs to the same page as an addition displays navigational links in the appropriate language as well as display the login fields (user/pass). Underneath the login an additional link takes them to the Guest registration page if user is not already registered with the site as a Guest.

21. Membership Login 228

i. This page may utilize same template for child pages for the current site for which it is being displayed

ii. Membership login may only be used if user has no existence of cookie or authenticated user/pass. User is then directed to a SSL secure connection presented with the user/pass fields to login.

1. Query Database

TABLE
[AuthenticedUsers]

| | |
|---|---|
| a. | UserName |
| b. | Password |

iii. Upon authentication user may directed to Personal Page. This section is a secure area and may utilize the security model described herein.

22 Personal Page 230

i. This page may utilize same template for child pages for the current site for which it is being displayed

ii. Page may display any new messages from the message board.

1. Message board abilities.

a. Text messages

b. May display any events listed for the given user.

i. If event is on the current day a link to the conferencing software may be provided.

ii. May include personal paragraph from database if one is present

1. Database Schema

| | |
|---|---|
| a. TABLE: [AuthenticedUsers] | |
| b. Content | (Text) |
| c. IsPersonal | (Boolean) |

23. Message Board 232

i. This page may utilize same template for child pages for the current site for which it is being displayed

ii. Dynamic display

1. Entering Message Board may display all messages posted for the given user from other users of which posted messages.

a. 20 at a time may be displayed on a page.

i. “Next 20” & “Previous 20” may be displayed for additional messages.

2. Listing display

a. Message Subject

b. Date Sent

c. Sender

d. Read (yes/no)

e. Message Type

i. Event

1. Conference time

ii. Message

f. Link to read message (button)

g. Link to delete message (button)

i. Deleting message may automatically archive into another area of the site accessible by a link provided above message board

ii. Content Control

1. User may only be displayed the messages for the current logged on user.

iii. Database Schema

TABLE
[MessageBoard]

| | | |
|---|---|---|
| 1. | MsgSubject | (Varchar) |
| 2. | MsgDate | (Datetime) |
| 3. | MsgTypeID | (Foreign Key) |
| 4. | MsgText | (Text) |
| 5. | IsRead | (Boolean) |
| 6. | FromRegisteredUserID | (Foreign Key) |
| 7. | ToRegisteredUserID | (Foreign Key) |

v. Message Posting

1. On bottom of list there may be present a button to post a message.

a. Depending on the user the following options may be provided.

i. Registered Users

1. These users may be company staff listed below.

a. President

b. Vice President

c. COO

d. CFO

e. Investor Relations

2. Once selected the user may fill in the appropriate fields

a. Subject

b. Message Text

ii. Company Staff

1. Choose recipient

a. Individual user

b. All users

c. Choose more than one

2. Once selected the user may fill in the appropriate fields

a. Subject

b. Select Message Type

c. General Message

d. Important Message

i. May show up as red in the dynamic list display

e. Message Text

vi. Event Posting

1. This is for the conferencing scheduling

2. User may separate list for displaying an event

3. Upon a day for an event the user mayhave on the top of the page the event name and time.

4. Only staff can post an event.

vii. Email Notification

1. Emails may go out for:

a. Message posting

b. Event posting

c. One day before event

24. Conferencing 234

i. This page may utilize same template for child pages for the current site for which it is being displayed

ii. Page may utilize 3^{rd} party software

5. Administration Site 236

25. Registered 238

i. Page may carry look and fell that is represented on the company site

ii. There maybe a drill down method to present the users.

1. Upon entering this page the admin may choose the domain for a list of registered users.

2. The admin can administer the account by clicking on the user.

a. The data may fill into text boxes to serve as a means of viewing as well as modifying.

b. Admin may have update/delete/close buttons as a selection located below the form.

3. Display of user list may display 20 on each page

4. Dynamic list display fields.

a. First Name

b. Last Name

c. Email

d. Access Log (link to access log for that user)

e. Authenticated (Yes/No display)

f. Disable Account/Enable Account (Button)

g. Create/Delete private site for this user.

i. This may allow users to enter thru private site.

h. User Type

i. List all

iii. As part of the navigation on this page the admin may have an add link navigating to a blank form with choice of domains to register under present represented by checkboxes. Submitting the form may populate the registered users with that entry.

1. No email may be sent upon submitting form to either the admin or the registered user.

iv. Database Schema

| | | |
|---|---|---|
| 1. | First Name | (Varchar) |
| 2. | Last Name | (Varchar) |
| 3. | Address | (Varchar) |
| 4. | City | (Varchar) |
| 5. | State | (Varchar) |
| 6. | Zip | (Varchar) |
| 7. | Country | (Varchar) |
| 8. | Phone | (Varchar) |
| 9. | Email | (Varchar) |

10. Additional Information (Text)

a. This may serve as any additional information that would be necessary to evaluate the user of the site.

v. Authenticating Users

1. A button may be present to allow a user to be one that can use the site.

a. Clicking this button may display if the current admin has permission to allow users to be authenticated.

2. Security layer may be in affect as per the domain dictates by default for each user. Admin may have the ability to override any or all security precautions.

3. When the admin clicks on the “Authenticate” button the page refreshs to another page displaying the username and dynamically generated password along with the email address to where the user/pass should be sent.

a. This page may also have a checkbox for sending this email. If checkbox is checked an email may be sent to the user for whom is authenticated to use pre subscribed domain.

b. Admin may also have ability to modify the email sent to the user at that time.

c. Clicking the “Continue to Authenticate” button may place the user in the Authenticated users list, which may allow the user to use the site for which he or she is subscribed too.

d. The admin may then be redirected to the Registered Users page

26. Authenticated 240

i. Authenticated User may be represented on the Registered user list as Authenticated.

27. Access Log 242

i. Access log for each user may be available on the Registered page

ii. Clicking on the link may take admin to separate page listing the access display log

1. Log may display

a. First Name

b. Last Name

c. Email

d. Page Accesses

e. Page Access Time

28. Categories 244

i. This page may serve as means of administering the Technologies for the site

ii. Entering a Category

1. Choose

a. Name

b. Domain to be listed under

i. list all domains present

c. Short description of category

iii. Submitting the form may post the new category into the database.

29. Languages 246

i. This page may serve as a means of administering the Languages for the site.

ii. Entering a Language

1. Choose

a. Name

b. Domain to be listed under

i. May list all domains present

c. Flag of Country.

iii. Submitting the form may post the new Language into the database.

30. Create User/Pass 248

31. Content 250

i. This page may serve as means of administering the Content for the site.

ii. Page may be have a drill down

iii. Entering Content

1. Choose

a. Name

b. Language

c. Domain to be listed under

i. May list all domains present

d. Short description of content

e. Content

32. Contact List 252

i. This page may serve as a means of administering the Contact list for the site.

ii. Contact list may include everyone from the Registered Users list as well as have a capability to display additional entries

iii. A dynamic list display may list all the entries on a page 20 at a time

1. Database Schema

| | | |
|---|---|---|
| a. | First Name | (Varchar) |
| b. | Last Name | (Varchar) |
| c. | Address | (Varchar) |
| d. | City | (Varchar) |
| e. | State | (Varchar) |
| f. | Zip | (Varchar) |
| g. | Country | (Varchar) |
| h. | Day Phone | (Varchar) |
| i. | Night Phone | (Varchar) |
| j. | Cell Phone | (Varchar) |
| k. | Email | (Varchar) |
| l. | NetMeetingIP | (Varchar) |
| m. | DatePosted | (Datetime) |
| n. | Additional Information | (Text) |

2. Display

a. First Name

b. Last Name

c. Email

d. Date Entered

e. Registered (yes/no)

f. Authorized (yes/no)

g. Link to detailed information

3. Detail

a. May list everything as per the database schema represents

b. May display in text boxes for modifying the information

i. Buttons

1. Update

2. Delete

a. May give additional text

box as to confirming the delete.

4. Add new Contact

a. May list everything as per the database schema represents

b. Posting message may make available immediately

33. Email/Video 254

i. Video email may be the used to send people video transmissions of administrator announcements or so desired personal messages to registered users as well as private individuals abroad.

ii. Sending a video email may require:

1. A video camera

a. To be installed on the client computer.

2. Video capture software—NetMeeting has such video capture capabilities and is recommended as the primary software to use for this application.

3. Instruction page as to steps involved sending the video captured clips used by staff.

4. Uploading the captured clips to the server.

a. May be done thru the browser.

5. Interface for typing messages.

6. Sending to Registered users and private individuals:

a. A multiple list display may enable staff to select registered users as recipients.

i. May be presented a choice for message board posting as well as email

b. A blank text box may be provided if so desired recipients are needed.

While this invention has been particularly shown and described with references to preferred embodiments thereof, it will be understood by those skilled in the art that various changes in form and details may be made therein without departing from the scope of the invention encompassed by the appended claims. For example, the password may be provided or otherwise defined prior to confirmation of accreditation, with access only enabled after confirmation. The use of the site is preferably made auditable by the use of software that collects data on the specific use of the site. Further, pages read, time spent per page, per visit, number of visits, area of country, time of day, number of communications to administrator, etc. may be logged. In addition, the back office system may be set up to allow the administration to follow each user's site use including the stage of a particular investor's process, for example, an investor making an investment, including the time frame that each user is at in the process that is ongoing (for example, of an investor).

What is claimed is:

1. A method of providing private information from a server over a network comprising:
providing a registration form, a user license agreement and private information on the server;
at a client, accessing the registration form and the user license agreement from the server as web page, completing the registration form and the user license agreement, and forwarding the completed registration form and the completed user license agreement to the server;
from the registration form and the user license agreement, authorizing access to the private information; and
at the client, accessing the private information from the server as a web page.

2. A method as claimed in claim 1 further comprising, from the server, transmitting a message instructing a client device linked to the client to preclude unauthorized use of the private information.

3. A method as claimed in claim 2 wherein the unauthorized use includes using the private information in violation of securities rules.

4. A method as claimed in claim 2 wherein the unauthorized use includes copying and printing of the private information.

5. A method as claimed in claim 1 wherein the private information includes at least one of a private offering and licensing information.

6. A method as claimed in claim 1 wherein a user at the client is an accredited investor or sophisticated investor under securities rules.

7. A method as claimed in claim 1 wherein the step of authorizing access includes assuring accreditation in accordance with securities rules.

8. A method as claimed in claim 1 further comprising, at the server, enabling a password for the client's access to the private information.

9. A method as claimed in claim 8 further comprising submitting a new password request in the event that the server denies access.

10. A method as claimed in claim 8 wherein the password is provided from the server to the client by electronic mail.

11. A method as claimed in claim 8 further comprising, during an initial log in from the client device using the password, flagging the password to preclude use of the password from a second client device.

12. A method as claimed in claim 11 further comprising returning a cookie having the password from the server to the client device to provide access to the private information from only the client device.

13. A method as claimed in claim 1 further comprising, at the client, accessing from the server an accreditation confirmation statement having information on securities rules.

14. A method as claimed in claim 1 further comprising, at the client, selecting a country from which the client is accessing the private information.

15. A method as claimed in claim 1 further comprising, at the client, selecting a language in which the private information is displayed.

16. A method as claimed in claim 1 wherein the server being at least one computer connected to the network.

17. A method as claimed in claim 1 wherein access to the private information by a search engine is blocked.

18. A method as claimed in claim 1 wherein the step of authorizing access includes confirming a reference provided in the registration form.

19. A method as claimed in claim 18 wherein the reference includes at least one of a broker, accountant, banker and attorney.

20. A method as claimed in claim 1 wherein the network is the Internet.

21. A method as claimed in claim 1 wherein the private information is a secondary private securities offer.

22. A method as claimed in claim 21 further comprising
at the client, accessing a purchase request form from the server, completing the purchase request form, and forwarding the purchase request form to the server to request purchase of the secondary private securities,
at the server, receiving the purchase request form and authorizing the purchase request in compliance with securities rules.

23. A method as claimed in claim 21 further comprising,
at the client, accessing a secondary private securities offer form, completing the secondary private securities offer form, and forwarding the secondary private securities offer form to request offer for sale of the secondary private securities,
at the server, receiving the secondary private securities offer form and authorizing the secondary private securities offer in compliance with securities rules.

24. A method as claimed in claim 1 wherein the web page is a broadcast channel web page transmitting the private information in a multimedia format.

25. A method of providing private information from a server over a network comprising:
providing a user license agreement and the private offering information on the server;
at a client, accessing the user license agreement, completing the user license agreement to the server, and forwarding the completed user license agreement to the server requesting access to the private information; and
from the user license agreement, assuring authorized access; and
downloading the private offering information from the server to the client.

26. A method as claimed in claim 25 wherein the private information includes at least one of a private offering, secondary private securities offer, and licensing information.

27. A method as claimed in claim 25 wherein assuring authorized access includes precluding access by an unaccredited investor in violation of securities rules.

28. A method as claimed in claim 25 wherein assuring authorized access includes precluding access from an unauthorized client device.

29. A method as claimed in claim 25 further comprising, from the user license agreement, assuring authorized use of the private information.

30. A method as claimed in claim 29 wherein assuring authorized use includes precluding the use of the private information in violation of securities rules.

31. A method as claimed in claim 29 wherein assuring authorized use includes precluding at least one of redistribution, republication and retransmission of private information.

32. A method as claimed in claim 29 wherein assuring authorized use includes precluding at least one of copying and printing of private information.

33. A method as claimed in claim 25 wherein the user license agreement form includes an accreditation confirmation statement having information on securities rules.

34. A method as claimed in claim 25 wherein the user license agreement includes securities transaction terms.

35. A method of providing private information from a server over a network comprising:
providing private information on the server;
at a client, requesting the private information;
authorizing a password for the client and returning a cookie from the server to the client linked to a client device to provide access to the private information with the password from only that client device; and
downloading the private information from the server to the client.

36. A method as claimed in claim 35 wherein the cookie being scripted to expire after a selected time by the server.

37. A method as claimed in claim 35 wherein the cookie being scripted to be crumbled at the client's request to access the private information.

38. A method as claimed in claim 35 further comprising, at the server, flagging the password to preclude the use of the password in a second login process.

39. A method as claimed in claim 35 further comprising accessing the cookie at the client to authorize access to the private information.

40. A method as claimed in claim 35 wherein the private information includes at least one of a private offering, secondary private securities offering and licensing information.

41. A method of providing private information from a server over the Internet comprising:
providing private information on the server;
at a client, requesting the private information;
from the server, transmitting a message instructing the client device to preclude unauthorized use of the private information; and
downloading the private information from the server to the client.

42. A method as claimed in claim 41 further comprising, accessing a cookie at the client to authorize access to the private information.

43. A method as claimed in claim 41 wherein the private information includes at least one of a private offering of securities and licensing information.

44. A method as claimed in claim 41 wherein the unauthorized use includes at least one of copying, caching and printing of the private information.

45. A method as claimed in claim 41 wherein the unauthorized use includes at least one of redistribution, republication and retransmission of the private information.

46. A method as claimed in claim 41 wherein the message includes opening a second browser window displaying the private information.

47. A method as claimed in claim 46 wherein the second browser window is in a manner free of providing a print option.

48. A method as claimed in claim 46 wherein the second browser window is in a manner free of providing access to the address of the displayed page.

49. A method as claimed in claim 41 wherein the message includes blocking caching of the private information.

50. A method as claimed in claim 41 wherein the message includes validating a browser on the client device.

51. A method as claimed in claim 41 wherein the message includes disabling key functions of the client device.

52. A method as claimed in claim 51 wherein the key functions are performed by a keyboard.

53. A method of providing private information from a server over the Internet comprising:
providing private information on the server;
at a client, requesting the private information;
from the server, returning a cookie to the client linked to a client device to provide access to the private information with a password from only that client device, and transmitting a message instructing the client device to preclude unauthorized use of the private information; and
downloading the private information from the server to the client.

54. A method as claimed in claim 53 further comprising, at a client, accessing a user license agreement form, completing the user license agreement form to the server, and forwarding the completed user license agreement form to the server assuring authorized access.

55. A method as claimed in claim 53 wherein the private information is a private offering.

56. A method as claimed in claim 53 further comprising, at the client, sending a request to purchase securities of the private offering, at the server, receiving the request and processing a transaction of securities.

57. A method as claimed in claim 53 further comprising assuring compliance with securities rules.

58. A method of processing a private securities transaction comprising:
providing a private securities offer form on the server;
at a client, accessing the private securities offer form from the server, completing the private securities offer, and forwarding the completed private securities offer form to the server; and
from the private securities offer form, authorizing private securities offer in compliance with securities rules.

59. A method of processing a private securities transaction comprising:
providing a plurality of private securities offers and a purchase request form on the server;
at a client, accessing the plurality of private securities offers form from the server, accessing the purchase request form, completing the purchase request form, and forwarding the purchase request form to the server;
at the server, receiving the purchase request form and processing the purchase request form in compliance with securities rules.

60. A system for private information delivery over a network, comprising:
a plurality of sources;
a database for storing a plurality of private information, each item of private information produced by and received from one of the plurality of sources;
at least one client linked to a client device; and
a server connected to the database and the at least one client over the network, the server comprising:
a user interface to receive a request for access to private information; and
a processor processing the request and transmitting a message instructing the client device to preclude unauthorized use of the private information.

61. A system of claim 60 wherein the message further instructs the client device to preclude unauthorized access of the private information.

62. The system of claim 60 wherein the private information includes at least one of a private offering, secondary private securities offering and licensing information.

63. A server in a private financial information network comprising:
means for connecting to a database storing the private financial information;
means for receiving a request to the private financial information from a client linked to a client device;
means for controlling unauthorized access to the private information; and
means for forwarding the private information from the database to the client.

64. The server of claim 63 further comprising means for transmitting a cookie to the client device to provide access to the offering information from only that client device;

65. The server of claim 63 further comprising means for controlling unauthorized use of the private information.

66. The server of claim 63 wherein means for controlling authorized access includes confirming accreditation in accordance with the securities law.

67. The server of claim 63 wherein means for controlling authorized access includes forming a user license agreement with the client.

68. A system for processing a private securities transaction over a network comprising:
a plurality of authorized users;
a database for storing a plurality of private securities offers, each item of offers produced by and received from one of the plurality of authorized users;
a server connected to the database and at least one authorized user over the network, the server comprising;
a user interface to receive a purchase request from the at least one authorized user;
an access control to preclude unauthorized access to private securities offers; and
a processor for processing the purchase request by accepting at least one offer from the plurality of offers in the database.

69. The system of claim 68 further comprising a use control to preclude unauthorized use of private securities offers.
